(19) United States
(12) Patent Application Publication
(10) Pub. No.: US 2025/0216656 A1
(43) Pub. Date: Jul. 3, 2025

(54) OPTICAL IMAGING SYSTEM

(71) Applicants: Samsung Electro-Mechanics Co., Ltd., Suwon-si (KR); Kumoh National Institute of Technology Industry-Academic Cooperation Foundation, Gumi-si (KR)

(72) Inventors: Jae Myung RYU, Gumi-si (KR); Hag Chul KIM, Suwon-si (KR); Yong Joo JO, Suwon-si (KR); Phil Ho JUNG, Suwon-si (KR)

(73) Assignees: Samsung Electro-Mechanics Co., Ltd., Suwon-si (KR); Kumoh National Institute of Technology Industry-Academic Cooperation Foundation, Gumi-si (KR)

(21) Appl. No.: 18/970,004

(22) Filed: Dec. 5, 2024

(30) Foreign Application Priority Data
Dec. 29, 2023 (KR) 10-2023-0196944
May 31, 2024 (KR) 10-2024-0071804

(51) Int. Cl. G02B 13/00; G02B 15/14

(52) U.S. Cl. CPC G02B 13/009; G02B 13/0045; G02B 13/0065; G02B 15/144113

(57) ABSTRACT

An optical imaging system includes a first lens group, a second lens group, a third lens group, and a fourth lens group sequentially disposed along an optical axis, and each including a plurality of lenses, wherein each of the first lens group and the fourth lens group has a positive refractive power, the optical imaging system further includes an aperture disposed between the third lens group and the fourth lens group, the first lens group, the aperture, and the fourth lens group are fixed, and the second lens group and the third lens group are configured to be movable along the optical axis, the optical imaging system further includes a reflective member including a reflective surface configured to change an optical path of the optical imaging system disposed in front of the first lens group, and the fourth lens group is a lens group disposed closest to the imaging surface.

### CROSS-REFERENCE TO RELATED APPLICATIONS

This application claims the benefit under 35 USC 119 (a) of Korean Patent Application Nos. 10-2023-0196944 filed on Dec. 29, 2023, and 10-2024-0071804 filed on May 31, 2024, in the Korean Intellectual Property Office, the entire disclosures of which are incorporated herein by reference for all purposes.

### BACKGROUND

### 1. Field of Invention

The present disclosure relates to an optical imaging system.

### 2. Description of Related Art

Recently, camera modules have been adopted as a basic feature in portable electronic devices including smartphones.

Additionally, recently, in order to indirectly implement an optical zoom effect, a method of mounting a plurality of camera modules having different focal lengths on portable electronic devices has been proposed.

However, this method not only requires a plurality of camera modules for an optical zoom effect, but also has a difference in terms of a field of view between the plurality of camera modules, and accordingly, when capturing an image at an intermediate magnification, imaging processing through software is required instead of an optical zoom, which may cause a problem of reduced image quality.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group, a second lens group, a third lens group, and a fourth lens group sequentially disposed in ascending numerical order along an optical axis of the optical imaging system away from an object side of the optical imaging system toward an imaging surface of the optical imaging system, and each including a plurality of lenses, wherein each of the first lens group and the fourth lens group has a positive refractive power as a whole, the optical imaging system further includes an aperture disposed between the third lens group and the fourth lens group, the first lens group, the aperture, and the fourth lens group are disposed at fixed positions on the optical axis, and the second lens group and the third lens group are configured to be movable along the optical axis, the optical imaging system further includes a reflective member including a reflective surface configured to change an optical path of the optical imaging system disposed in front of the first lens group, and the fourth lens group is a lens group disposed closest to the imaging surface.

0.95≤Mw/Mt≤1.05 may be satisfied, where Mw is a magnification of the fourth lens group in a wide-angle mode of the optical imaging system when the optical imaging system is focused on an object at infinity, and Mt is a magnification of the fourth lens group in a telephoto mode of the optical imaging system when the optical imaging system is focused on an object at infinity.

0.9≤L14/L4≤1.2 may be satisfied, where L14 is a distance along the optical axis from an image-side surface of a lens disposed closest to the second lens group, among the lenses included in the first lens group, to an object-side surface of a lens disposed closest to the third lens group, among the lenses included in the fourth lens group, and L4 is a distance along the optical axis from the object-side surface of the lens disposed closest to the third lens group, among the lenses included in the fourth lens group, to the imaging surface.

0.8≤D11/D_last≤1.3 may be satisfied, where D11 is an effective diameter of an object-side surface of a lens disposed closest to the reflective member, among the lenses included in the first lens group, and D_last is an effective diameter of an image-side surface of a lens disposed closest to the imaging surface, among the lenses included in the fourth lens group.

0.5≤D41/(2×IMG HT)≤0.8 may be satisfied, where D41 is an effective diameter of an object-side surface of a lens disposed closest to the third lens group, among the lenses included in the fourth lens group, and IMG HT is one half of a diagonal length of the imaging surface.

1.0≤T_dG3/I_dG3≤1.4 may be satisfied, where T_dG3 is a maximum movement amount of the third lens group in a telephoto mode of the optical imaging system, and I_dG3 is a maximum movement amount of the third lens group when the optical imaging system is focused on an object at infinity.

1.5≤fG1/D_last≤2.5 may be satisfied, where fG1 is a focal length of the first lens group, and D_last is an effective diameter of an image-side surface of a lens disposed closest to the imaging surface, among the lenses included in the fourth lens group.

−0.6≤(R13−R14)/(R13+R14)≤−0.2 may be satisfied, where R13 is a radius of curvature of an object-side surface of a lens disposed closest to the third lens group, among the lenses included in the fourth lens group, and R14 is a radius of curvature of an image-side surface of the lens closest to the third lens group, among the lenses included in the fourth lens group.

1.5≤ft/L4≤2.2 may be satisfied, where ft is an overall focal length of the optical imaging system in a telephoto mode of the optical imaging system when the optical imaging system is focused on an object at infinity, and L4 is a distance along the optical axis from an object-side surface of a lens disposed closest to the third lens group, among the lenses included in the fourth lens group, to the imaging surface.

The second lens group may have a negative refractive power, and the third lens group may have a positive refractive power.

The first lens group may include a first lens and a second lens, the first lens and the second lens may have refractive powers having opposite signs, and among the first and second lenses, an Abbe number of a lens having a positive refractive power may be greater than 50, and an Abbe number of a lens having a negative refractive power may be less than 35.

The second lens group may include a third lens and a fourth lens, the third lens and the fourth lens may have refractive powers having opposite signs, and among the third and fourth lenses, an Abbe number of a lens having a positive refractive power may be less than 21, and an Abbe number of a lens having a negative refractive power may be greater than 45.

The third lens group may include a fifth lens and a sixth lens, the fifth lens and the sixth lens may have refractive powers having opposite signs, and among the fifth and sixth lenses, an Abbe number of a lens having a positive refractive power may be greater than 50, and an Abbe number of a lens having a negative refractive power is less than 30.

The fourth lens group may include a seventh lens, an eighth lens, a ninth lens, and a tenth lens, and the seventh lens may have a convex object-side surface in a paraxial region thereof and an Abbe number greater than 50.

The aperture may be disposed in front of the seventh lens, and the seventh lens may have a positive refractive power.

The ninth lens or the tenth lens may have at least one inflection point on either one or both of an object-side surface and an image-side surface thereof.

In another general aspect, an optical imaging system includes a first lens group, a second lens group, a third lens group, and a fourth lens group sequentially disposed in ascending numerical order along an optical axis of the optical imaging system away from an object side of the optical imaging system toward an imaging surface of the optical imaging system, and each including a plurality of lenses, and an aperture disposed between the third lens group and the fourth lens group, wherein each of the first lens group and the fourth lens group has a positive refractive power as a whole and is disposed at a fixed position on the optical axis, the second lens group is configured to be movable along the optical axis to adjust a focal length of the optical imaging system between a wide-angle mode of the optical imaging system and a telephoto mode of the optical imaging system, the third lens group is configured to be movable along the optical axis to adjust a focus position of the optical imaging system as the second lens group moves along the optical axis to adjust the focal length of the optical imaging system, and 0.95×Mw/Mt≤1.05 is satisfied, where Mw is a magnification of the fourth lens group in the wide-angle mode when the optical imaging system is focused on an object at infinity, and Mt is a magnification of the fourth lens group in the telephoto mode when the optical imaging system is focused on an object at infinity.

1.0≤T_dG3/I_dG3≤1.4 may be satisfied, where T_dG3 is a movement amount of the third lens group between a position of the third lens group in the telephoto mode when the optical imaging system is focused on an object at a near focus distance, and a position of the third lens group in the telephoto mode when the optical imaging system is focused on an object at infinity, and I_dG3 is a movement amount of the third lens group between a position of the third lens group in the wide-angle mode when the image is focused on an object at infinity, and a position of the third lens group in the telephoto mode when the optical imaging system is focused on an object at infinity.

The second lens group may have a negative refractive power as a whole, and the third lens group may have a positive refractive power as a whole.

The aperture may be aligned with a vertex of an object-side surface of a lens disposed closest to the third lens group, among the lenses included in the fourth lens group.

In another general aspect, an optical imaging system includes a first lens group, a second lens group, a third lens group, and a fourth lens group sequentially disposed in ascending numerical order along an optical axis of the optical imaging system away from an object side of the optical imaging system toward an imaging surface of the optical imaging system, and each including a plurality of lenses, and an aperture disposed between the third lens group and the fourth lens group, wherein each of the first lens group and the fourth lens group has a positive refractive power as a whole and is disposed at a fixed position on the optical axis, the second lens group is configured to be movable along the optical axis to adjust a focal length of the optical imaging system between a wide-angle mode of the optical imaging system and a telephoto mode of the optical imaging system, the third lens group is configured to be movable along the optical axis to adjust a focus position of the optical imaging system as the second lens group moves along the optical axis to adjust the focal length of the optical imaging system, and 0.9≤L14/L4≤1.2 is satisfied, where L14 is a distance along the optical axis from an image-side surface of a lens disposed closest to the second lens group, among the lenses included in the first lens group, to an object-side surface of a lens disposed closest to the third lens group, among the lenses included in the fourth lens group, and L4 is a distance along the optical axis from the object-side surface of the lens disposed closest to the third lens group, among the lenses included in the fourth lens group, to the imaging surface.

0.8≤D11/D_last≤1.3 may be satisfied, where D11 is an effective diameter of an object-side surface of a lens closest to the object side of the optical imaging system, among the lenses included in the first lens group, and D_last is an effective diameter of an image-side surface of a lens disposed closest to the imaging surface, among the lenses included in the fourth lens group.

The second lens group may have a negative refractive power as a whole, and the third lens group may have a positive refractive power as a whole.

The aperture may be aligned with a vertex of an object-side surface of a lens disposed closest to the third lens group, among the lenses included in the fourth lens group.

Other features and aspects will be apparent from the following detailed description, the drawings, and the claims.

### BRIEF DESCRIPTION OF DRAWINGS

FIG. 1 is a view illustrating a wide-angle mode of an optical imaging system according to a first embodiment of the present disclosure.

FIG. 2 is a view illustrating a telephoto mode of the optical imaging system according to the first embodiment of the present disclosure.

FIG. 3 is a view illustrating a wide-angle mode of an optical imaging system according to a second embodiment of the present disclosure.

FIG. 4 is a view illustrating a telephoto mode of the optical imaging system according to the second embodiment of the present disclosure.

FIG. 5 is a view illustrating a wide-angle mode of an optical imaging system according to a third embodiment of the present disclosure.

FIG. 6 is a view illustrating a telephoto mode of the optical imaging system according to the third embodiment of the present disclosure.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the drawings, the thickness, size, and shape of the lenses may be somewhat exaggerated for ease of illustration, and specifically, the shapes of the lens surfaces in the drawings are only presented as examples but are not limited thereto.

An optical imaging system according to an example embodiment of the present disclosure may be mounted in a portable electronic device. For example, the optical imaging system may be a component of a camera module mounted in a portable electronic device. The portable electronic device may be a portable electronic device such as a mobile communication terminal, a smartphone, or a tablet PC.

In an example embodiment, a first lens (or a forwardmost lens) is a lens closest to an object side of the optical imaging system, and a last lens (or a rearmost lens) refers to a lens closest to an imaging surface (or an image sensor) of the optical imaging system.

Additionally, in this specification, numerical values of a radius of curvature of a lens surface, a thickness of a lens, a distance between lenses or other elements, a focal length of a lens, and other quantities are expressed in millimeters, and a field of view (FOV) of the optical imaging system is expressed in degrees.

Additionally, in the description of a shape of each lens, a statement that a surface of a lens is convex indicates that the surface is convex in a paraxial region of the surface, and a statement that a surface of a lens is concave indicates that the surface is concave in a paraxial region of the surface.

Accordingly, even if a surface of a lens is described as convex, an edge portion of the surface may be concave. Similarly, even if a surface of a lens is described as concave, an edge portion of the surface may be convex.

A paraxial region of a lens surface is a central portion of the lens surface surrounding the optical axis of the lens surface in which light rays incident to the lens surface make a small angle θ to the optical axis, and the approximations sin θ≈θ, tan θ=θ, and cos θ≈1 are valid.

An imaging surface may be a virtual surface on which an image of an object is focused by the optical imaging system. Alternatively, the imaging surface may be one surface of an image sensor on which an image is focused.

The optical imaging system according to an example embodiment of the present disclosure includes a plurality of lens groups. For example, the optical imaging system may include a first lens group, a second lens group, a third lens group, and a fourth lens group.

Each of the first to fourth lens groups includes a plurality of lenses. In an example embodiment, the optical imaging system may include ten lenses.

In an example embodiment, the optical imaging system includes a first lens, a second lens, a third lens, a fourth lens, a fifth lens, a sixth lens, a seventh lens, an eighth lens, a ninth lens, and a tenth lens sequentially disposed in ascending numerical order along an optical axis of the optical imaging system away from an object side of the optical imaging system toward an image side of the optical imaging system.

The optical imaging system according to an example embodiment of the present disclosure may further include a reflective member having a reflective surface configured to change an optical path of the optical imaging system. For example, the reflective member may be a mirror or a prism.

The optical path through the reflective member may be bent to elongate the optical path in a relatively narrow space. The reflective member is disposed in front of the first lens group.

Accordingly, the optical imaging system may be miniaturized while allowing the optical imaging system to have a long focal length.

Additionally, the optical imaging system may further include an image sensor for converting an image of an object into an electric signal.

Additionally, the optical imaging system may further include an infrared blocking filter (hereinafter referred to as a filter) for blocking infrared rays. The filter may be disposed between the rearmost lens of the optical imaging system and the image sensor.

Additionally, the optical imaging system may further include an aperture disposed between the third lens group and the fourth lens group. For example, the aperture may be disposed in front of the fourth lens group. In an example embodiment, the aperture may be disposed between the sixth lens and the seventh lens.

In an example embodiment, the first lens group may include a first lens and a second lens, the second lens group may include a third lens and a fourth lens, the third lens group may include a fifth lens and a sixth lens, and the fourth lens group may include a seventh lens, an eighth lens, a ninth lens, and a tenth lens.

Since the first lens group is disposed in a forwardmost position in the optical imaging system, waterproofing and dustproofing are easily implemented when the first lens group is fixed.

The first lens group includes at least one lens having a positive refractive power and a biconvex shape (i.e., an object-side surface and an image-side surface are each convex in a paraxial region thereof).

In an example embodiment, the first lens group may include two lenses (e.g., a first lens and a second lens).

The first lens may have a biconvex shape. Additionally, an object-side surface of the second lens may be concave in a paraxial region thereof. An image-side surface of the second lens may be convex or concave in a paraxial region thereof.

The first lens and the second lens have refractive powers having opposite signs, and a composite focal length of the first lens and the second lens (i.e., a focal length of the first lens group G1) has a positive value.

Additionally, the first lens and the second lens may be made of materials having different optical properties. For example, an Abbe number of the first lens and an Abbe number of the second lens may be different from each other.

In an example embodiment, the Abbe number of one lens of the first lens and the second lens may be greater than 50, and the Abbe number of the other lens may be less than 35.

In an example embodiment, the Abbe number of a lens having a positive refractive power, among the first lens and the second lens, may be greater than 50, and the Abbe number of a lens having a negative refractive power, among the first lens and the second lens, may be less than 35.

The second lens group includes at least one lens having a negative refractive power and a biconcave shape (i.e., an object-side surface and an image-side surface are each concave in a paraxial region thereof). Additionally, the second lens group may include at least one lens having an Abbe number exceeding 45.

In an example embodiment, the second lens group may include two lenses (e.g., a third lens and a fourth lens). The third lens may have a biconvex shape. Alternatively, the third lens may have a shape in which an object-side surface is concave in a paraxial region thereof and an image-side surface is convex in a paraxial region thereof. Additionally, the fourth lens may have a biconcave shape.

The third lens and the fourth lens have refractive powers having opposite signs, and composite focal length of the third lens and the fourth lens (i.e., a focal length of the second lens group G2) has a negative value.

Additionally, the third lens and the fourth lens may be made of materials having different optical properties. For example, an Abbe number of the third lens and an Abbe number of the fourth lens may be different from each other.

In an example embodiment, the Abbe number of one lens of the third lens and the fourth lens may be greater than 45, and the Abbe number of the other lens may be less than 21.

In an example embodiment, the Abbe number of a lens having a positive refractive power, among the third lens and the fourth lens, may be less than 21, and the Abbe number of a lens having a negative refractive power, among the third lens and the fourth lens, may be greater than 45.

The third lens group may include at least one lens having a positive refractive power and a biconvex shape.

In an example embodiment, the third lens group may include two lenses (e.g., the fifth lens and the sixth lens).

The fifth lens may have a biconvex shape. Additionally, the sixth lens may have a shape in which an object-side surface is convex in a paraxial region thereof and an image-side surface is concave in a paraxial region thereof.

The fifth lens and the sixth lens have refractive powers having opposite signs, and a composite focal length of the fifth lens and the sixth lens (i.e., a focal length of the third lens group G3) has a positive value.

Additionally, the fifth lens and the sixth lens may be made of materials having different optical properties. For example, an Abbe number of the fifth lens and an Abbe number of the sixth lens may be different from each other.

In an example embodiment, the Abbe number of one lens of the fifth lens and the sixth lens may be greater than 50, and the Abbe number of the other lens may be less than 30.

In an example embodiment, the Abbe number of a lens having a positive refractive power, among the fifth lens and the sixth lens, may be greater than 50, and the Abbe number of a lens having a negative refractive power, among the fifth lens and the sixth lens, may be less than 30.

The fourth lens group includes a plurality of lenses, and has a positive refractive power as a whole.

The fourth lens group may include at least two lenses having an Abbe number greater than 50.

In an example embodiment, the fourth lens group includes a seventh lens, an eighth lens, a ninth lens, and a tenth lens.

The fourth lens group may further include an aperture disposed in front of the seventh lens. A lens (e.g., the seventh lens) disposed closest to the aperture, among the plurality of lenses included in the fourth lens group, may have a positive refractive power.

Among the lenses included in the fourth lens group, a forwardmost lens may have a convex object-side surface in a paraxial region thereof, and an Abbe number thereof may be greater than 50.

Among the lenses included in the fourth lens group, a lens (e.g., a rearmost lens) disposed closest to the imaging surface may have an inflection point. For example, the tenth lens may have at least one inflection point on either one or both of an object-side surface and an image-side surface. Alternatively, a lens immediately in front of the rearmost lens, e.g., the ninth lens, may have at least one inflection point on either one or both of an object-side surface and an image-side surface.

At least one lens group among the first to fourth lens groups may be moved to change an overall focal length of the optical imaging system.

For example, a distance between the first lens group and the second lens group may be variable. For example, the first lens group may be fixed, and the second lens group may be configured to be movable in an optical axis direction. As the second lens group moves away from an object side of the optical imaging system toward an image side of the optical imaging system, the optical imaging system may be changed from a wide-angle mode to a normal mode to a telephoto mode. In other words, as the second lens group moves in the optical axis direction, the overall focal length of the optical imaging system may be changed.

At least one lens group among the first lens group to the fourth lens group may be moved to correct a focus position according to the change in the overall focal length of the optical imaging system.

For example, the third lens group may be configured to be movable in the optical axis direction. As the third lens group is moved, a distance between the second lens group and the third lens group, and a distance between the third lens group and the fourth lens group, may be changed.

For example, when the overall focal length of the optical imaging system is changed from the wide-angle mode to the normal mode to the telephoto mode, the third lens group may be moved away from the image side of the optical imaging system toward the object side of the optical imaging system, or away from the object side of the optical imaging system toward the image side of the optical imaging system, to correct the focus position.

The first lens group and the fourth lens group may be fixed.

Each of the second lens group and the third lens group may include three or fewer lenses. Since each of the second lens group and the third lens group is movable in the optical axis direction, a driving load may be reduced by limiting the number of lenses included in the second lens group and the third lens group.

In an example embodiment, the second lens group may be moved along the optical axis so that the overall focal length of the optical imaging system may be changed (e.g., an optical zoom function may be performed), and the third lens group may be moved along the optical axis to correct the focus position according to the change in the overall focal length of the optical imaging system.

Accordingly, the optical imaging system according to an example embodiment of the present disclosure has an optical zoom function.

The optical imaging system according to an example embodiment of the present disclosure has the characteristics of a telephoto lens having a relatively narrow field of view and a long focal length.

The optical imaging system according to an example embodiment of the present disclosure may further include a reflective member having a reflective surface configured to change an optical path of the optical imaging system. For example, the reflective member may be a mirror or a prism.

The optical path of the optical imaging system may be bent by the reflective member to elongate the optical path in a relatively narrow space.

The reflective member may be disposed in front of the first lens group. The reflective member may be rotated around two axes to correct shaking during capturing an image.

That is, when shaking occurs due to factors such as the user's hand shaking while capturing an image or shooting video, the reflection member may be rotated around two axes in response to the shaking, thereby compensating for the shaking.

Since the reflection member has a relatively lighter weight than the optical imaging system, the shaking may be easily compensated for with less driving force.

A plurality of lenses of the optical imaging system have aspherical surfaces.

In an example embodiment, the object-side surface and the image-side surface of each of the first to tenth lenses may be aspherical.

The aspherical surfaces of the lenses are defined by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to E are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

According to an example embodiment of the present disclosure, the optical imaging system may satisfy any one or any combination of any two or more of the following Conditional Expressions 1 to 8:

$$0.95 \leq Mw / Mt \leq 1.05 \qquad ( Conditional Expression 1 )$$

$$0.9 \leq L 14 / L 4 \leq 1.2 \qquad ( Conditional Expression 2 )$$

$$0.8 \leq D 11 / D\_last \leq 1.3 \qquad ( Conditional Expression 3 )$$

$$0.5 \leq D 41 / ( 2 \times IMG HT ) \leq 0.8 \qquad ( Conditional Expression 4 )$$

$$1. \leq T\_dG3 / I\_dG3 \leq 1.4 \qquad ( Conditional Expression 5 )$$

$$1.5 \leq fG 1 / D\_last \leq 2.5 \qquad ( Conditional Expression 6 )$$

$$- 0.6 \leq ( R 13 - R 14 ) / ( R 13 + R 14 ) \leq - 0.2 \qquad ( Conditional Expression 7 )$$

$$1.5 \leq ft / L 4 \leq 2.2 \qquad ( Conditional Expression 8 )$$

In an example embodiment, the optical imaging system may satisfy Conditional Expression 1, 0.95≤Mw/Mt≤1.05, where Mw is a magnification of the fourth lens group in the wide-angle mode when the optical imaging system is focused on an object at infinity, and Mt is a magnification of the fourth lens group in the telephoto mode when the optical imaging system is focused on an object at infinity.

Conditional Expression 1 ensures that a difference between an Fno of the wide-angle mode and an Fno of the telephoto mode is not large. Fno is an F number of the optical imaging system.

In an example embodiment, the optical imaging system may satisfy Conditional Expression 2, 0.9≤L14/L4≤1.2, where L14 is a distance along the optical axis between the first lens group and the fourth lens group. For example, L14 is a distance along the optical axis from an image-side surface of a lens closest to the second lens group, among the lenses included in the first lens group, to an object-side surface of a lens closest to the third lens group, among the lenses included in the fourth lens group. L4 is a distance along the optical axis from an object-side surface of a forwardmost lens, among the lenses included in the fourth lens group, to the imaging surface.

Conditional Expression 2 minimizes the effective diameters of the lenses included in the optical imaging system. In the present disclosure, the aperture may be disposed in front of the object-side surface of the forwardmost lens, among the lenses included in the fourth lens group. Accordingly, when 0.9≤L14/L4≤1.2 is satisfied, the aperture may be disposed at about the middle of an optical axis length (also known as a total track length) of the optical imaging system, which is a distance along the optical axis from an object-side surface of a forwardmost lens, among the lenses included in the first lens group, to the imaging surface. In the present disclosure, the lenses included in the optical imaging system have effective diameters that become larger as the distance from the aperture increases. Accordingly, the effective diameters of the lenses included in the optical imaging system may be minimized by satisfying 0.9≤ L14/L4≤1.2. An effective diameter of a lens surface is a diameter of a portion of the lens surface through which light actually passes, and is equal to twice an effective radius of the lens surface. An object-side surface of a lens and an image-side surface of the lens may have different effective diameters.

In an example embodiment, the optical imaging system may satisfy Conditional Expression 3, 0.8≤D11/D_last≤1.3, where D11 is an effective diameter of the object-side surface of the forwardmost lens, among the lenses included in the first lens group, and D_last is an effective diameter of an image-side surface of a rearmost lens, among the lenses included in the fourth lens group. Conditional Expression 3 minimizes the effective diameters of the lenses included in the optical imaging system.

In an example embodiment, the optical imaging system may satisfy Conditional Expression 4, 0.5≤D41/(2×IMG HT)≤0.8, where D41 is an effective diameter of the object-side surface of the forwardmost lens, among the lenses included in the fourth lens group, and IMG HT is one half of a diagonal length of the imaging surface.

Conditional Expression 4 is related to a diameter of the aperture of the optical imaging system. In the present disclosure, the aperture may be disposed in front of the object-side surface of the forwardmost lens, among the lenses included in the fourth lens group. Accordingly, the diameter of the aperture may be determined by satisfying 0.5≤ D41/(2×IMG HT)≤0.8, and accordingly, an appropriate Fno may be secured.

In an example embodiment, the optical imaging system may satisfy Conditional Expression 5, 1.0≤T_dG3/I_dG3≤1.4, where T_dG3 is a movement amount of the third lens group between a position of the third lens group in the telephoto mode when the optical imaging system is focused on an object at a near focus distance (e.g., 500 mm), and a position of the third lens group in the telephoto mode when the optical imaging system is focused on an object at infinity (i.e., a movement amount of the third lens group during focusing), and I_dG3 is a movement amount of the third lens group between a position of the third lens group in the wide-angle mode when the image is focused on an object at infinity, and a position of the third lens group in the telephoto mode when the optical imaging system is focused on an object at infinity (i.e., a movement amount of the third lens group when changing the field of view of the optical imaging system, i.e. when changing between the wide-angle mode and the telephoto mode). In other words, T_dG3 is a maximum movement amount of the third lens group in a telephoto mode of the optical imaging system, and I_dG3 is a maximum movement amount of the third lens group when the optical imaging system is focused on an object at infinity.

By satisfying 1.0≤T_dG3/I_dG3≤1.4, sufficient aberration correction may be achieved while reducing a size of the optical imaging system.

In an example embodiment, the optical imaging system may satisfy Conditional Expression 6, 1.5≤fG1/D_last≤2.5, where, fG1 is a focal length of the first lens group.

By satisfying 1.5≤fG1/D_last≤2.5, the optical imaging system may capture a bright image while reducing the size of the optical imaging system.

In an example embodiment, the optical imaging system may satisfy Conditional Expression 7, −0.6≤(R13−R14)/(R13+R14)≤−0.2, where R13 is a radius of curvature of the object-side surface of the forwardmost lens, among the lenses included in the fourth lens group, and R14 is a radius of curvature of the image-side surface of the forwardmost lens, among the lenses included in the fourth lens group.

The forwardmost lens of the fourth lens group is a lens disposed close to the aperture. Accordingly, spherical aberration may be appropriately corrected by satisfying −0.6≤(R13−R14)/(R13+R14)≤−0.2.

In an example embodiment, the optical imaging system may satisfy Conditional Expression 8, 1.5≤ft/L4≤2.2, where ft is an overall focal length of the optical imaging system in the telephoto mode when the optical imaging system is focused on an object at infinity.

An appropriate zoom ratio may be determined by satisfying 1.5≤ft/L4≤2.2.

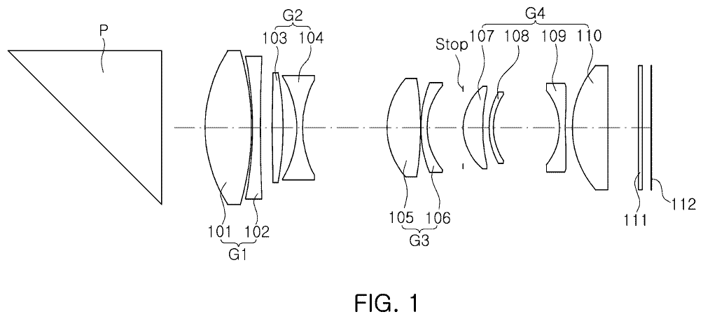

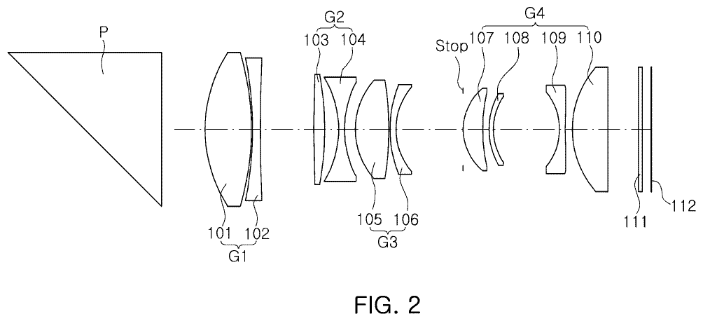

FIG. 1 is a view illustrating a wide-angle mode of an optical imaging system according to a first embodiment of the present disclosure, and FIG. 2 is a view illustrating a telephoto mode of the optical imaging system according to the first embodiment of the present disclosure.

The optical imaging system according to the first embodiment of the present disclosure will be described with reference to FIGS. 1 and 2.

The optical imaging system according to the first embodiment of the present disclosure includes a first lens group G1, a second lens group G2, a third lens group G3, and a fourth lens group G4. Additionally, the optical imaging system includes a reflective member P disposed in front of the first lens group G1.

In order from an object side of the optical imaging system, the first lens group G1 includes a first lens 101 and a second lens 102, the second lens group G2 includes a third lens 103 and a fourth lens 104, the third lens group G3 includes a fifth lens 105 and a sixth lens 106, and the fourth lens group G4 includes a seventh lens 107, an eighth lens 108, a ninth lens 109, and a tenth lens 110.

An aperture (Stop) may be disposed in front of the seventh lens 107, which is the forwardmost lens of the fourth lens group G4. A distance along the optical axis between the aperture (Stop) and a vertex of an object-side surface of the seventh lens 107 may be 0.

Additionally, the optical imaging system may further include a filter 111 and an image sensor (not shown).

The optical imaging system according to the first embodiment of the present disclosure may focus an image of an object on an imaging surface 112. The imaging surface 112 may be a surface on which an image is focused by the optical imaging system. For example, the imaging surface 112 maybe one surface of the image sensor on which light is received.

In the first embodiment of the present disclosure, the reflective member P may be a prism, but alternatively may be a mirror.

At least one lens group among the first lens group G1 to the fourth lens group G4 may be moved to change an overall focal length of the optical imaging system. For example, the first lens group G1 and the fourth lens group G4 may be fixed, and the second lens group G2 may be moved along the optical axis to change the overall focal length of the optical imaging system. That is, as the second lens group G2 is moved away from the object side of the optical imaging system toward an image side of the optical imaging system, the overall focal length of the optical imaging system may be changed.

Additionally, at least one lens group among the first lens group G1 to the fourth lens group G4 may be moved to correct a focus position according to the change in the overall focal length of the optical imaging system. For example, when the overall focal length of the optical imaging system is changed by moving the second lens group G2, the third lens group G3 may be moved along the optical axis to correct the focus position.

The characteristics of each lens of the optical imaging system according to the first embodiment of the present disclosure (e.g., a radius of curvature, a thickness of a lens or a distance between lenses, a refractive index, an Abbe number, an effective radius, and a focal length) are shown in Table 1 below. An asterisk by a lens surface number indicates that the lens surface is an aspherical lens surface.

TABLE 1

| Surface | Radius of | Thickness or | Refractive | Abbe | Effective | Focal | |
|---|---|---|---|---|---|---|---|
| No. | Curvature | Distance | Index | No. | Radius | Length | Note |
| Object | Infinity | D0 | | | | | |
| 1* | 10.967 | 2.720 | 1.53485 | 55.74 | 5.000 | 12.7491 | First |
| 2* | −16.470 | 0.100 | | | 4.805 | | Lens |
| 3* | −19.778 | 0.400 | 1.63918 | 23.49 | 4.660 | −33.5429 | Group |
| 4* | −257.179 | D1 | | | 4.425 | | |
| 5* | 119.659 | 0.630 | 1.67075 | 19.24 | 3.600 | 32.4291 | Second |
| 6* | −26.528 | 0.802 | | | 3.516 | | Lens |
| 7* | −5.933 | 0.300 | 1.53485 | 55.74 | 3.368 | −5.9766 | Group |
| 8* | 7.053 | D2 | | | 3.089 | | |
| 9* | 4.976 | 1.940 | 1.54401 | 55.99 | 3.200 | 7.6156 | Third |
| 10* | −21.349 | 0.050 | | | 3.124 | | Lens |
| 11* | 9.699 | 0.300 | 1.63918 | 23.49 | 2.929 | −13.9347 | Group |
| 12* | 4.587 | D3 | | | 2.696 | | |
| 13* | 3.853 | 1.120 | 1.54401 | 55.99 | 2.660 | 10.0625 | Fourth |
| 14* | 11.678 | 0.384 | | | 2.553 | | Lens |
| 15* | 5.010 | 0.210 | 1.67075 | 19.24 | 2.313 | −41.9356 | Group |
| 16* | 4.181 | 3.861 | | | 2.200 | | |
| 17* | −6.749 | 0.300 | 1.54401 | 55.99 | 2.451 | −7.3959 | |
| 18* | 10.119 | 0.453 | | | 2.879 | | |
| 19* | 4.325 | 2.070 | 1.56717 | 37.40 | 3.978 | 9.4049 | |
| 20* | 18.900 | 1.826 | | | 4.042 | | |
| 21 | Infinity | 0.210 | 1.51680 | 64.20 | 4.018 | | Filter |
| 22 | Infinity | 0.500 | | | 4.016 | | |
| 23 | Infinity | | | | | | Imaging |
| | | | | | | | Surface |

Table 2 below shows various characteristics of the optical imaging system according to the first embodiment of the present disclosure in a wide mode, a normal mode, and a telephoto mode of the optical imaging system for an object at infinity, and in the wide mode, the normal mode, and the telephoto mode for an object at a near focus position of the optical imaging system, i.e., a nearest position of an object at which the optical imaging system can focus an image of the object on the imaging surface 112.

TABLE 2

| | Object at Infinity | | | Object at Near Focus Distance | | |
|---|---|---|---|---|---|---|
| | Wide | Normal | Telephoto | Wide | Normal | Telephoto |
| Quantity | Mode | Mode | Mode | Mode | Mode | Mode |
| D0 | Infinity | Infinity | Infinity | 500 | 500 | 500 |
| D1 | 0.700000 | 2.044029 | 3.188058 | 0.700000 | 2.044029 | 3.188058 |
| D2 | 4.953786 | 3.238241 | 0.961882 | 5.793102 | 4.457743 | 2.745975 |
| D3 | 2.164745 | 2.536261 | 3.668591 | 1.325429 | 1.316759 | 1.884498 |
| f | 12.311673 | 15.140427 | 19.172097 | 11.347098 | 13.461912 | 16.189165 |
| MAG | | | | 0.022669 | 0.027031 | 0.032875 |
| HFOV | 17.720 | 14.565 | 11.596 | 18.688 | 15.746 | 13.025 |
| Fno | 2.081 | 2.098 | 2.149 | 2.045 | 2.046 | 2.071 |
| OAL | 25.995 | 25.995 | 25.995 | 25.995 | 25.995 | 25.995 |

In Table 2, D0 is an object distance, D1 is a distance along the optical axis between the second lens 102 and the third lens 103, D2 is a distance along the optical axis between the fourth lens 104 and the fifth lens 105, and D3 is a distance along the optical axis between the sixth lens 106 and the seventh lens 107.

f is an overall focal length of the optical imaging system, MAG is a magnification of the optical imaging system, HFOV is a one half of a field of view of the optical imaging system, Fno is an F number of the optical imaging system, and OAL is an optical axis length of the optical imaging system, i.e., a distance along the optical axis from the object-side surface of the first lens 101 to the imaging surface 112. OAL is also known as total track length (TTL). MAG is equal to a height of an image of an object formed by the optical imaging system divided by a height of the object.

In the first embodiment of the present disclosure, the first lens group G1 has a positive refractive power as a whole, the second lens group G2 has a negative refractive power as a whole, the third lens group G3 has a positive refractive power as a whole, and the fourth lens group G4 has a positive refractive power as a whole.

The first lens 101 has a positive refractive power, and an object-side surface and an image-side surface of the first lens 101 are convex in paraxial regions thereof.

The second lens 102 has a negative refractive power, an object-side surface of the second lens 102 is concave in a paraxial region thereof, and an image-side surface of the second lens 102 is convex in a paraxial region thereof.

The third lens 103 has a positive refractive power, and an object-side surface and an image-side surface of the third lens 103 are convex in paraxial regions thereof.

The fourth lens 104 has a negative refractive power, and an object-side surface and an image-side surface of the fourth lens 104 are concave in paraxial regions thereof.

The fifth lens 105 has a positive refractive power, and an object-side surface and an image-side surface of the fifth lens 105 are convex in paraxial regions thereof.

The sixth lens 106 has a negative refractive power, an object-side surface of the sixth lens 106 is convex in a paraxial region thereof, and an image-side surface of the sixth lens 106 is concave in a paraxial region thereof.

The seventh lens 107 has a positive refractive power, an object-side surface of the seventh lens 107 is convex in a paraxial region thereof, and an image-side surface of the seventh lens 107 is concave in a paraxial region thereof. An aperture (Stop) may be disposed in front of the object-side surface of the seventh lens 107.

The eighth lens 108 has a negative refractive power, an object-side surface of the eighth lens 108 is convex in a paraxial region thereof, and an image-side surface of the eighth lens 108 is concave in a paraxial region thereof.

The ninth lens 109 has a negative refractive power, and an object-side surface and an image-side surface of the ninth lens 109 are concave in paraxial regions thereof.

The tenth lens 110 has a positive refractive power, an object-side surface of the tenth lens 110 is convex in a paraxial region thereof, and an image-side surface of the tenth lens 110 is concave in a paraxial region thereof.

The tenth lens 110 may have at least one inflection point on either one or both of the object-side surface and the image-side surface.

Each surface of the first lens 101 to the tenth lens 110 has aspherical coefficients as shown in Table 3 below. For example, an object-side surface and an image-side surface of each of the first lens 101 to the tenth lens 110 are aspherical.

TABLE 3

| | Conic | Fourth | Sixth | Eighth | Tenth | Twelfth |
|---|---|---|---|---|---|---|
| Surface | Constant | Coefficient | Coefficient | Coefficient | Coefficient | Coefficient |
| No. | (K) | (A) | (B) | (C) | (D) | (E) |
| 1 | −1 | 1.64361E−04 | 2.03980E−06 | 3.20344E−08 | 1.05720E−09 | |
| 2 | −1 | −1.54830E−05 | 6.84004E−06 | 1.64381E−07 | −5.37366E−09 | |
| 3 | −1 | 3.74329E−05 | 3.50138E−06 | 4.45347E−07 | −1.00906E−08 | |
| 4 | −1 | 2.41818E−04 | −1.76307E−06 | 4.26541E−07 | −4.17915E−09 | |
| 5 | −1 | −1.24652E−04 | −3.61666E−05 | 2.87619E−06 | 4.35359E−08 | |
| 6 | −1 | −5.51249E−04 | −3.78929E−05 | 6.93848E−06 | −1.72340E−07 | |
| 7 | −1 | 9.08158E−04 | −2.00537E−06 | 7.27972E−07 | −1.09927E−07 | |
| 8 | −1 | 5.34893E−04 | 1.64932E−05 | −4.96175E−06 | 1.96299E−07 | |
| 9 | −1 | 4.45937E−04 | 1.43007E−05 | −6.46728E−07 | −2.07191E−07 | |
| 10 | −1 | 4.88726E−04 | −3.40225E−05 | 6.25505E−07 | −5.17678E−08 | |
| 11 | −1 | −5.10383E−05 | 7.66726E−06 | 2.44957E−06 | 2.84719E−07 | |
| 12 | −1 | 1.26771E−03 | 6.17021E−05 | 8.61884E−06 | 1.93190E−07 | |
| 13 | −1 | 2.00245E−03 | 2.44511E−05 | 6.27064E−06 | 3.15464E−07 | |
| 14 | −1 | −2.35379E−04 | −1.76675E−05 | 3.56122E−06 | −3.20862E−07 | |
| 15 | −1 | −7.83224E−04 | −5.11976E−05 | 8.76046E−06 | −1.61996E−07 | |
| 16 | −1 | 4.90766E−04 | −4.09631E−06 | −6.03457E−06 | 3.37571E−06 | |
| 17 | −1 | −2.71367E−03 | −1.13826E−03 | −3.53180E−05 | 8.48362E−06 | |
| 18 | −1 | −1.25589E−02 | 2.09746E−03 | −2.47165E−04 | 1.21388E−05 | |
| 19 | −1 | −1.51775E−02 | 2.70620E−03 | −2.60008E−04 | 1.33115E−05 | −2.76961E−07 |
| 20 | −1 | −7.39666E−03 | 4.81701E−04 | 7.37274E−06 | −9.28109E−07 | |

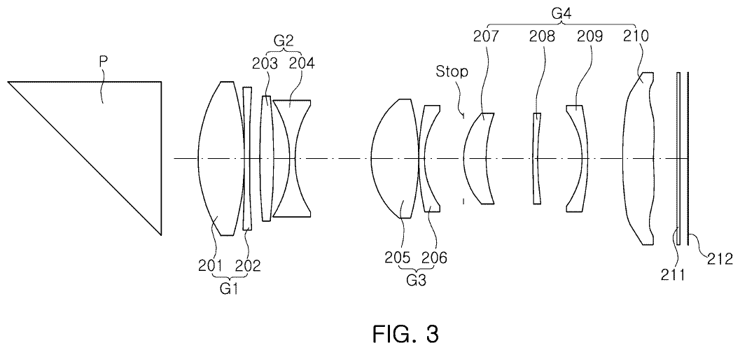

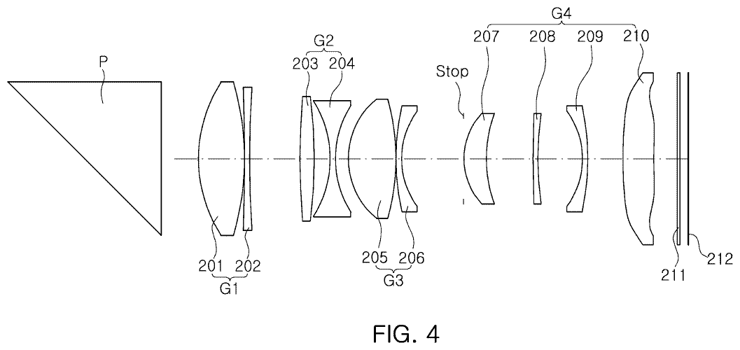

FIG. 3 is a view illustrating a wide-angle mode of an optical imaging system according to a second embodiment of the present disclosure, and FIG. 4 is a view illustrating a telephoto mode of the optical imaging system according to the second embodiment of the present disclosure.

The optical imaging system according to the second embodiment of the present disclosure will be described with reference to FIGS. 3 and 4.

The optical imaging system according to the second embodiment of the present disclosure includes a first lens group G1, a second lens group G2, a third lens group G3, and a fourth lens group G4. Additionally, the optical imaging system includes a reflective member P disposed in front of the first lens group G1.

In order from an object side of the optical imaging system, the first lens group G1 includes a first lens 201 and a second lens 202, the second lens group G2 includes a third lens 203 and a fourth lens 204, the third lens group G3 includes a fifth lens 205 and a sixth lens 206, and the fourth lens group G4 includes a seventh lens 207, an eighth lens 208, a ninth lens 209, and a tenth lens 210.

An aperture (Stop) may be disposed in front of the seventh lens 207, which is a forwardmost lens of the fourth lens group G4. A distance along the optical axis between the aperture (Stop) and a vertex of an object-side surface of the seventh lens 207 may be 0.

Additionally, the optical imaging system may further include a filter 211 and an image sensor (not shown).

The optical imaging system according to the second embodiment of the present disclosure may focus an image of an object on an imaging surface 212. The imaging surface 212 may be a surface on which an image is focused by the optical imaging system. For example, the imaging surface 212 may be one surface of the image sensor on which light is received.

In the second embodiment of the present disclosure, the reflective member P may be a prism, but alternatively may be a mirror.

At least one lens group among the first lens group G1 to the fourth lens group G4 may be moved to change an overall focal length of the optical imaging system. For example, the first lens group G1 and the fourth lens group G4 may be fixed, and the second lens group G2 may be moved along the optical axis to change the overall focal length of the optical imaging system. That is, as the second lens group G2 is moved away from the object side of the optical imaging system toward an image side of the optical imaging system, the overall focal length of the optical imaging system may be changed.

Additionally, at least one lens group among the first lens group G1 to the fourth lens group G4 may be moved to correct a focus position according to the change in the overall focal length of the optical imaging system. For example, when the overall focal length of the optical imaging system is changed by moving the second lens group G2, the third lens group G3 may be moved along the optical axis to correct the focus position.

The characteristics of each lens of the optical imaging system according to the second embodiment of the present disclosure (e.g., a radius of curvature, a thickness of a lens or a distance between lenses, a refractive index, an Abbe number, an effective radius, and a focal length) are shown in Table 4 below. An asterisk by a lens surface number indicates that the lens surface is an aspherical lens surface.

TABLE 4

| Surface | Radius of | Thickness or | Refractive | Abbe | Effective | Focal | |
|---|---|---|---|---|---|---|---|
| No. | Curvature | Distance | Index | No. | Radius | Length | Note |
| Object | Infinity | D0 | | | | | |
| 1* | 11.775 | 2.850 | 1.49710 | 81.56 | 5.400 | 16.2401 | First |
| 2* | −23.614 | 0.050 | | | 5.214 | | Lens |
| 3* | −75.952 | 0.300 | 1.63918 | 23.49 | 5.053 | −75.2797 | Group |
| 4* | 131.496 | D1 | | | 4.925 | | |
| 5* | 48.004 | 0.840 | 1.68043 | 18.15 | 4.375 | 45.9782 | Second |
| 6* | −89.188 | 1.048 | | | 4.225 | | Lens |
| 7* | −7.209 | 0.300 | 1.53485 | 55.74 | 4.088 | −6.5422 | Group |
| 8* | 6.898 | D2 | | | 3.774 | | |
| 9* | 5.705 | 2.980 | 1.54401 | 55.99 | 4.200 | 8.0618 | Third |
| 10* | −15.475 | 0.050 | | | 4.045 | | Lens |
| 11* | 29.445 | 0.300 | 1.63918 | 23.49 | 3.705 | −15.5434 | Group |
| 12* | 7.399 | D3 | | | 3.346 | | |
| 13* | 4.913 | 1.420 | 1.54401 | 55.99 | 3.200 | 17.9000 | Fourth |
| 14* | 8.906 | 2.970 | | | 3.125 | | Lens |
| 15* | 31.892 | 0.300 | 1.54401 | 55.99 | 3.172 | −168.1180 | Group |
| 16* | 23.568 | 2.839 | | | 3.188 | | |
| 17* | −8.928 | 0.300 | 1.54401 | 55.99 | 3.423 | −21.2087 | |
| 18* | −39.938 | 2.263 | | | 3.809 | | |
| 19* | 14.927 | 1.930 | 1.56717 | 37.40 | 5.949 | −95.5986 | |
| 20 | 11.157 | 1.502 | | | 6.026 | | |
| 21 | Infinity | 0.210 | 1.51680 | 64.20 | 6.022 | | Filter |
| 22 | Infinity | 0.500 | | | 6.021 | | |
| 23 | Infinity | | | | | | Imaging |
| | | | | | | | Surface |

Table 5 below shows various characteristics of the optical imaging system according to the second embodiment of the present disclosure in a wide mode, a normal mode, and a telephoto mode of the optical imaging system for an object at infinity, and in the wide mode, the normal mode, and the telephoto mode for an object at a near focus position of the optical imaging system, i.e., a nearest position of an object at which the optical imaging system can focus an image of the object on the imaging surface 212.

TABLE 5

| | Object at Infinity | | | Object at Near Focus Distance | | |
|---|---|---|---|---|---|---|
| | Wide | Normal | Telephoto | Wide | Normal | Telephoto |
| Quantity | Mode | Mode | Mode | Mode | Mode | Mode |
| D0 | Infinity | Infinity | Infinity | 500 | 500 | 500 |
| D1 | 0.700000 | 2.023956 | 3.069678 | 0.700000 | 2.023956 | 3.069678 |
| D2 | 4.859453 | 3.093620 | 0.948144 | 5.874325 | 4.539290 | 2.965802 |
| D3 | 2.495142 | 2.937019 | 4.036773 | 1.480270 | 1.491349 | 2.019115 |
| f | 18.701256 | 22.907717 | 28.474176 | 16.516032 | 19.230555 | 22.324997 |
| MAG | | | | 0.033924 | 0.040134 | 0.047791 |
| HFOV | 17.552 | 14.478 | 11.735 | 18.689 | 15.837 | 13.339 |
| Fno | 2.435 | 2.463 | 2.636 | 2.374 | 2.378 | 2.412 |
| OAL | 31.007 | 31.007 | 31.007 | 31.007 | 31.007 | 31.007 |

In Table 5, DO is an object distance, D1 is distance along the optical axis distance between the second lens 202 and the third lens 203, D2 is a distance along the optical axis distance between the fourth lens 204 and the fifth lens 205, and D3 is distance along the optical axis distance between the sixth lens 206 and the seventh lens 207.

f is an overall focal length of the optical imaging system, MAG is a magnification of the optical imaging system, HFOV is one half of a field of view of the optical imaging system, Fno is an F number of the optical imaging system, and OAL is an optical axis length of the optical imaging system, i.e., a distance along the optical axis from the object-side surface of the first lens 201 to the imaging surface 212. OAL is also know as total track length (TTL). MAG is equal to a height of an image of an object formed by the optical imaging system divided by a height of the object.

In the second embodiment of the present disclosure, the first lens group G1 has a positive refractive power as a whole, the second lens group G2 has a negative refractive power as a whole, the third lens group G3 has a positive refractive power as a whole, and the fourth lens group G4 has a positive refractive power as a whole.

The first lens 201 has a positive refractive power, and an object-side surface and an image-side surface of the first lens 201 are convex in paraxial regions thereof.

The second lens 202 has a negative refractive power, and an object-side surface and an image-side surface of the second lens 202 are concave in paraxial regions thereof.

The third lens 203 has a positive refractive power, and an object-side surface and an image-side surface of the third lens 203 are convex in paraxial regions thereof.

The fourth lens 204 has a negative refractive power, and an object-side surface and an image-side surface of the fourth lens 204 are concave in paraxial regions thereof.

The fifth lens 205 has a positive refractive power, and an object-side surface and an image-side surface of the fifth lens 205 are convex in paraxial regions thereof.

The sixth lens 206 has a negative refractive power, an object-side surface of the sixth lens 206 is convex in a paraxial region thereof, and an image-side surface of the sixth lens 206 is concave in a paraxial region thereof.

The seventh lens 207 has a positive refractive power, an object-side surface of the seventh lens 207 is convex in a paraxial region thereof, and an image-side surface of the seventh lens 207 is concave in a paraxial region thereof. An aperture (Stop) may be disposed in front of the object-side surface of the seventh lens 207.

The eighth lens 208 has a negative refractive power, an object-side surface of the eighth lens 208 is convex in a paraxial region thereof, and an image-side surface of the eighth lens 208 is concave in a paraxial region thereof.

The ninth lens 209 has a negative refractive power, an object-side surface of the ninth lens 209 is concave in a paraxial region thereof, and an image-side surface of the ninth lens 209 is convex in a paraxial region thereof.

The tenth lens 210 has a negative refractive power, an object-side surface of the tenth lens 210 is convex in a paraxial region thereof, and an image-side surface of the tenth lens 210 is concave in a paraxial region thereof.

The tenth lens 210 may have at least one inflection point on either one or both of the object-side surface and the image-side surface.

Each surface of the first lens 201 to the tenth lens 210 has aspherical coefficients as shown in Table 6 below. For example, the object-side surface and the image-side surface of each of the first lens 201 to the tenth lens 210 are aspherical.

TABLE 6

| | Conic | Fourth | Sixth | Eighth | Tenth | Twelfth |
|---|---|---|---|---|---|---|
| Surface | Constant | Coefficient | Coefficient | Coefficient | Coefficient | Coefficient |
| No | (K) | (A) | (B) | (C) | (D) | (E) |
| 1 | −1 | 6.03668E−05 | 1.91841E−06 | −2.46768E−09 | 7.93086E−10 | |
| 2 | −1 | 5.37431E−05 | 1.87185E−06 | 1.97253E−08 | −5.04085E−10 | |
| 3 | −1 | 1.90358E−05 | 8.83136E−07 | 6.77437E−08 | −1.00207E−10 | |
| 4 | −1 | 4.92727E−05 | 8.77111E−07 | 5.13574E−08 | 1.79397E−09 | |
| 5 | −1 | −3.12723E−04 | −4.88743E−06 | 7.92198E−07 | −6.76229E−09 | |
| 6 | −1 | −4.28038E−04 | −7.22033E−06 | 1.71884E−06 | −5.50886E−08 | |
| 7 | −1 | 6.21684E−04 | −2.05216E−05 | 4.53517E−07 | −1.62087E−08 | |
| 8 | −1 | −1.08317E−04 | 4.84511E−06 | −1.28536E−06 | 5.37996E−08 | |
| 9 | −1 | 5.82896E−04 | 1.00706E−05 | 4.07157E−07 | −4.10505E−08 | |
| 10 | −1 | 6.24269E−04 | −2.12576E−05 | 6.90626E−07 | −1.49519E−08 | |
| 11 | −1 | 1.10750E−05 | 5.34695E−06 | 1.38647E−06 | 1.75757E−08 | |
| 12 | −1 | 8.68849E−04 | 5.88803E−05 | 1.20041E−06 | 2.69085E−07 | |
| 13 | −1 | 8.79393E−04 | −9.14385E−06 | 2.24500E−06 | −6.27885E−08 | |
| 14 | −1 | 2.85295E−05 | −3.88700E−05 | 2.10194E−06 | −1.10697E−07 | |
| 15 | −1 | −9.52832E−04 | 3.08705E−05 | 7.33418E−08 | −3.07966E−07 | |
| 16 | −1 | −3.74950E−04 | 6.70325E−05 | −5.59175E−07 | −7.62433E−08 | |
| 17 | −1 | −2.29025E−03 | −2.28723E−04 | 2.36625E−05 | −7.58261E−07 | |
| 18 | −1 | −1.56820E−03 | −2.88540E−05 | 1.00014E−05 | −2.51403E−07 | |
| 19 | −1 | −5.19437E−03 | 4.82477E−04 | −2.05953E−05 | 4.72527E−07 | −4.48377E−09 |
| 20 | −1 | −9.88363E−03 | 5.57785E−04 | −1.15264E−05 | 7.46302E−08 | |

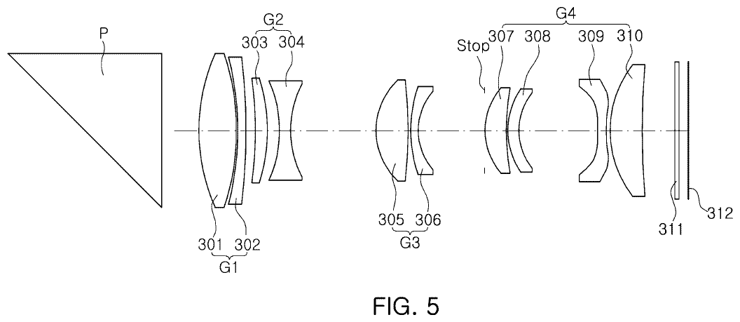

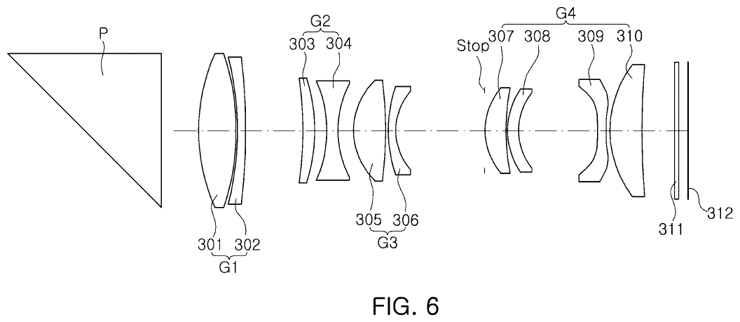

FIG. 5 is a view illustrating a wide-angle mode of an optical imaging system according to a third embodiment of the present disclosure, and FIG. 6 is a view illustrating a telephoto mode of the optical imaging system according to the third embodiment of the present disclosure.

The optical imaging system according to the third embodiment of the present disclosure will be described with reference to FIGS. 5 and 6.

The optical imaging system according to the third embodiment of the present disclosure includes a first lens group G1, a second lens group G2, a third lens group G3, and a fourth lens group G4. Additionally, the optical imaging system includes a reflective member P disposed in front of the first lens group G1.

In order from an object side of the optical imaging system, the first lens group G1 includes a first lens 301 and a second lens 302, the second lens group G2 includes a third lens 303 and a fourth lens 304, the third lens group G3 includes a fifth lens 305 and a sixth lens 306, and the fourth lens group G4 includes a seventh lens 307, a eighth lens 308, a ninth lens 309, and a tenth lens 310.

An aperture (Stop) may be disposed in front of the seventh lens 307, which is the frontmost lens of the fourth lens group G4. A distance along the optical axis between the aperture (Stop) and a vertex of an object-side surface of the seventh lens 307 may be 0.

Additionally, the optical imaging system may further include a filter 311 and an image sensor (not shown).

The optical imaging system according to the third embodiment of the present disclosure may focus an image of an object on an imaging surface 312. The imaging surface 312 may be a surface on which an image is focused by the optical imaging system. For example, the imaging surface 312 may be one surface of the image sensor on which light is received.

In the third embodiment of the present disclosure, the reflective member P may be a prism, but alternatively may be a mirror.

At least one lens group among the first lens group G1 to the fourth lens group G4 may be moved to change an overall focal length of the optical imaging system. For example, the first lens group G1 and the fourth lens group G4 may be fixed, and the second lens group G2 may be moved along the optical axis to change the overall focal length of the optical imaging system. That is, as the second lens group G2 is moved from away the object side of the optical imaging system toward an image side of the optical imaging system, the overall focal length of the optical imaging system may be changed.

Additionally, at least one lens group among the first lens group G1 to the fourth lens group G4 may be moved to correct a focus position according to the change in the overall focal length of the optical imaging system. For example, when the overall focal length of the optical imaging system is changed by moving the second lens group G2, the third lens group G3 may be moved along the optical axis to correct the focus position.

The characteristics of each lens of the optical imaging system according to the third embodiment of the present disclosure (e.g., a radius of curvature, a thickness of the lens or distance between lenses, a refractive index, an Abbe number, an effective radius, and a focal length) are shown in Table 7 below. An asterisk by a lens surface number indicates that the lens surface is an aspherical lens surface.

TABLE 7

| Surface | Radius of | Thickness or | Refractive | Abbe | Effective | Focal | |
|---|---|---|---|---|---|---|---|
| No. | Curvature | Distance | Index | No. | Radius | Length | Note |
| Object | Infinity | D0 | | | | | |
| 1* | 14.746 | 2.000 | 1.54401 | 55.99 | 4.600 | 13.4306 | First |
| 2* | −13.790 | 0.100 | | | 4.481 | | Lens |
| 3* | −16.765 | 0.400 | 1.66076 | 20.38 | 4.386 | −53.8896 | Group |
| 4* | −31.982 | D1 | | | 4.245 | | |
| 5* | −58.208 | 0.670 | 1.67075 | 19.24 | 3.150 | 25.1739 | Second |
| 6* | −13.149 | 0.628 | | | 3.117 | | Lens |
| 7* | −6.462 | 0.550 | 1.54401 | 55.99 | 2.930 | −5.4850 | Group |
| 8* | 5.710 | D2 | | | 2.799 | | |
| 9* | 4.266 | 1.760 | 1.54401 | 55.99 | 3.029 | 6.3865 | Third |
| 10* | −16.001 | 0.100 | | | 2.909 | | Lens |
| 11* | 10.157 | 0.400 | 1.63918 | 23.49 | 2.648 | −10.0686 | Group |
| 12* | 3.879 | D3 | | | 2.350 | | |
| 13* | 4.438 | 1.140 | 1.54401 | 55.99 | 2.550 | 11.3652 | Fourth |
| 14* | 14.303 | 0.100 | | | 2.519 | | Lens |
| 15* | 4.507 | 0.550 | 1.67075 | 19.24 | 2.489 | −41.2660 | Group |
| 16* | 3.686 | 4.219 | | | 2.319 | | |
| 17* | −9.993 | 0.450 | 1.54401 | 55.99 | 2.676 | −8.1314 | |
| 18* | 8.063 | 0.200 | | | 3.098 | | |
| 19* | 3.818 | 1.700 | 1.56717 | 37.40 | 3.900 | 9.5447 | |
| 20* | 10.867 | 1.749 | | | 3.948 | | |
| 21 | Infinity | 0.210 | 1.51680 | 64.20 | 4.100 | | Filter |
| 22 | Infinity | 0.500 | | | 4.100 | | |
| 23 | Infinity | | | | | | Imaging |
| | | | | | | | Surface |

Table 8 below shows various characteristics of the optical imaging system according to the third embodiment of the present disclosure in a wide mode, a normal mode, and a telephoto mode of the optical imaging system for an object at infinity, and in the wide mode, the normal mode, and the telephoto mode for an object at a near focus position of the optical imaging system, i.e., a nearest position of an object at which the optical imaging system can focus an image of the object on the imaging surface 312.

TABLE 8

| | Object at Infinity | | | Object at Near Focus Distance | | |
|---|---|---|---|---|---|---|
| | Wide | Normal | Telephoto | Wide | Normal | Telephoto |
| Quantity | Mode | Mode | Mode | Mode | Mode | Mode |
| D0 | infinity | infinity | infinity | 500 | 500 | 500 |
| D1 | 0.500000 | 1.703804 | 2.907608 | 0.500000 | 1.703804 | 2.907608 |
| D2 | 4.534471 | 3.069026 | 0.799534 | 5.221949 | 4.039939 | 2.275124 |
| D3 | 3.534293 | 3.795934 | 4.861622 | 2.846815 | 2.825021 | 3.386032 |
| f | 12.314838 | 14.867541 | 19.121632 | 11.435021 | 13.399489 | 16.368017 |
| MAG | | | | 0.022945 | 0.027025 | 0.033424 |
| HFOV | 17.716 | 14.821 | 11.626 | 18.527 | 15.775 | 12.826 |
| Fno | 2.401 | 2.419 | 2.491 | 2.364 | 2.365 | 2.411 |
| OAL | 25.995 | 25.995 | 25.995 | 25.995 | 25.995 | 25.995 |

In Table 8, DO is an object distance, D1 is a distance along the optical axis between the second lens 302 and the third lens 303, D2 is a distance along the optical axis between the fourth lens 304 and the fifth lens 305, and D3 is a distance along the optical axis between the sixth lens 306 and the seventh lens 307.

f is an overall focal length of the optical imaging system, MAG is a magnification of the optical imaging system, HFOV is a one half of a field of view of the optical imaging system, Fno is an F number of the optical imaging system, and OAL is an optical axis length of the optical imaging system, i.e., distance along the optical axis from the object-side surface of the first lens 301 to the imaging surface 312. OAL is also known as a total track length (TTL). MAG is equal to a height of an image of an object formed by the optical imaging system divided by a height of the object.

In the third embodiment of the present disclosure, the first lens group G1 has a positive refractive power as a whole, the second lens group G2 has a negative refractive power as a whole, the third lens group G3 has a positive refractive power as a whole, and the fourth lens group G4 has a positive refractive power as a whole.

The first lens 301 has a positive refractive power, and an object-side surface and an image-side surface of the first lens 301 are convex in paraxial regions thereof.

The second lens 302 has a negative refractive power, an object-side surface of the second lens 302 is concave in a paraxial region thereof, and an image-side surface of the second lens 302 is convex in a paraxial region thereof.

The third lens 303 has a positive refractive power, an object-side surface of the third lens 303 is concave in a paraxial region thereof, and an image-side surface of the third lens 303 is convex in a paraxial region thereof.

The fourth lens 304 has a negative refractive power, and an object-side surface and an image-side surface of the fourth lens 304 are concave in paraxial regions thereof.

The fifth lens 305 has a positive refractive power, and an object-side surface and an image-side surface of the fifth lens 305 are convex in paraxial regions thereof.

The sixth lens 306 has a negative refractive power, an object-side surface of the sixth lens 306 is convex in a paraxial region thereof, and an image-side surface of the sixth lens 306 is concave in a paraxial region thereof.

The seventh lens 307 has a positive refractive power, an object-side surface of the seventh lens 307 is convex in a paraxial region thereof, and an image-side surface of the seventh lens 307 is concave in a paraxial region thereof. An aperture (Stop) may be disposed in front of the object-side surface of the seventh lens 307.

The eighth lens 308 has a negative refractive power, an object-side surface of the eighth lens 308 is convex in a paraxial region thereof, and an image-side surface of the eighth lens 308 is concave in a paraxial region thereof.

The ninth lens 309 has a negative refractive power, and an object-side surface and an image-side surface of the ninth lens 309 are concave in paraxial regions thereof.

The ninth lens 309 may have at least one inflection point on either one or both of the object-side surface and the image-side surface.

The tenth lens 310 has a positive refractive power, an object-side surface of the tenth lens 310 is convex in a paraxial region thereof, and an image-side surface of the tenth lens 310 is concave in a paraxial region thereof.

Each surface of the first lens 301 to the tenth lens 310 has aspherical coefficients as shown in Table 9 below. For example, the object-side surface and the image-side surface of each of the first lens 301 to the tenth lens 310 are aspherical.

TABLE 9

| | Conic | Fourth | Sixth | Eighth | Tenth | Twelfth |
|---|---|---|---|---|---|---|
| Surface | Constant | Coefficient | Coefficient | Coefficient | Coefficient | Coefficient |
| No. | (K) | (A) | (B) | (C) | (D) | (E) |
| 1 | −1 | −2.70396E−05 | 4.48024E−05 | −2.53576E−06 | 5.53905E−08 | |
| 2 | −1 | −1.26621E−03 | 2.81554E−04 | −1.71815E−05 | 3.46448E−07 | |
| 3 | −1 | −1.05995E−04 | 1.71874E−05 | −8.16902E−07 | 2.39481E−08 | |
| 4 | −1 | 1.22318E−03 | −2.34741E−04 | 1.59826E−05 | −3.40084E−07 | |
| 5 | −1 | 1.95522E−04 | −5.04713E−04 | 6.26776E−05 | −2.56031E−06 | |
| 6 | −1 | 1.49687E−03 | −8.51981E−04 | 1.04172E−04 | −4.21500E−06 | |
| 7 | −1 | 3.33050E−03 | −1.21349E−03 | 1.67724E−04 | −7.55246E−06 | |
| 8 | −1 | −5.00649E−04 | −3.80667E−04 | 6.96227E−05 | −3.58837E−06 | |
| 9 | −1 | 1.86090E−04 | 2.42686E−04 | −6.80424E−05 | 5.25637E−06 | |
| 10 | −1 | 2.71954E−03 | −4.79302E−04 | 2.12720E−05 | 1.73414E−06 | |
| 11 | −1 | 1.47611E−03 | −6.13200E−04 | 1.02532E−04 | −5.34321E−06 | |
| 12 | −1 | 1.85955E−03 | −2.71234E−04 | 1.16175E−04 | −9.23044E−06 | |
| 13 | −1 | 2.52358E−03 | −4.34334E−05 | 3.92180E−05 | −5.20136E−06 | |
| 14 | −1 | 2.60743E−03 | −7.27598E−04 | 1.21357E−04 | −1.11506E−05 | |
| 15 | −1 | −8.10679E−04 | −5.76209E−04 | 1.53834E−04 | −8.39013E−06 | |
| 16 | −1 | −1.88936E−03 | 1.73422E−04 | 2.43882E−05 | 1.15170E−05 | |
| 17 | −1 | 9.42916E−03 | −7.03953E−03 | 5.53324E−04 | 1.25053E−06 | |
| 18 | −1 | −2.04987E−03 | −2.91296E−03 | 2.48803E−04 | −3.32941E−06 | |
| 19 | −1 | −2.23118E−02 | 5.39348E−03 | −7.30892E−04 | 4.67625E−05 | −1.09678E−06 |
| 20 | −1 | −1.47695E−02 | 2.49908E−03 | −2.38997E−04 | 1.29793E−05 | −2.96343E−07 |

Table 10 below shows the values of the quantities Mw, Mt, L14, L4, D11, D41, 2×IMG HT, D_last, T_dG3, I_dG3, fG1, R13, R14, and ft in Conditional Expressions 1 to 8, as well as a focal length fG2 of the second lens group G2, a focal length fG3 of the third lens group G3, and a focal length fG4 of the fourth lens group G4, for the first, second, and third embodiments of the optical imaging system according to the present disclosure.

TABLE 10

| Quantity | Embodiment 1 | Embodiment 2 | Embodiment 3 |
|---|---|---|---|
| Mw | 0.241697078 | 0.413969246 | 0.271739823 |
| Mt | 0.240884695 | 0.413255436 | 0.270926915 |
| L14 | 11.841 | 13.573 | 12.677 |
| L4 | 10.934 | 14.234 | 10.818 |
| D11 | 10 | 10.8 | 9.2 |
| D41 | 5.32 | 6.4 | 5.1 |
| 2 × IMG HT | 7.2 | 11.4 | 7.2 |
| D_last | 8.084 | 12.052 | 7.896 |
| T_dG3 | 1.784093 | 2.017658 | 1.475590 |
| I_dG3 | 1.503846 | 1.541631 | 1.327329 |
| fG1 | 19.460104 | 20.220155 | 17.682005 |
| fG2 | −7.60266 | −7.92345 | −7.27064 |
| fG3 | 13.65687 | 13.53069 | 12.57085 |
| fG4 | 15.19574 | 48.00535 | 16.06743 |
| R13 | 3.853 | 4.913 | 4.438 |
| R14 | 11.678 | 8.906 | 14.303 |
| ft | 19.172097 | 28.474176 | 19.121632 |

Table 11 below shows the values of Conditional Expressions 1 to 8 for the first, second, and third embodiments of the optical imaging system according to the present disclosure calculated based on the values of Mw, Mt, L14, L4, D11, D41, 2×IMG HT, D_last, T_dG3, I_dG3, fG1, R13, R14, and ft in Table 10 above.

TABLE 11

| No. | Conditional Expression | Emb. 1 | Emb. 2 | Emb. 3 |
|---|---|---|---|---|
| 1 | 0.95 ≤ Mw/Mt ≤ 1.05 | 1.0034 | 1.0017 | 1.0030 |
| 2 | 0.9 ≤ L14/L4 ≤ 1.2 | 1.0830 | 0.9536 | 1.1718 |
| 3 | 0.8 ≤ D11/D_last ≤ 1.3 | 1.2370 | 0.8961 | 1.1651 |
| 4 | 0.5 ≤ D41/(2 × IMG HT) ≤ 0.8 | 0.7389 | 0.5614 | 0.7083 |
| 5 | 1.0 ≤ T_dG3/I_dG3 ≤ 1.4 | 1.1864 | 1.3088 | 1.1117 |
| 6 | 1.5 ≤ fG1/D_last ≤ 2.5 | 2.4072 | 1.6777 | 2.2394 |
| 7 | −0.6 ≤ (R13 − R14)/(R13 + | | | |
| | R14) ≤ −0.2 | | | |
| 8 | 1.5 ≤ ft/L4 ≤ 2.2 | | | |

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group, a second lens group, a third lens group, and a fourth lens group sequentially disposed in ascending numerical order along an optical axis of the optical imaging system away from an object side of the optical imaging system toward an imaging surface of the optical imaging system, and each comprising a plurality of lenses,
wherein each of the first lens group and the fourth lens group has a positive refractive power as a whole,
the optical imaging system further comprises an aperture disposed between the third lens group and the fourth lens group,
the first lens group, the aperture, and the fourth lens group are disposed at fixed positions on the optical axis, and the second lens group and the third lens group are configured to be movable along the optical axis,
the optical imaging system further comprises a reflective member comprising a reflective surface configured to change an optical path of the optical imaging system disposed in front of the first lens group, and
the fourth lens group is a lens group disposed closest to the imaging surface.

2. The optical imaging system according to claim 1, wherein 0.95≤Mw/Mt≤1.05 is satisfied, where Mw is a magnification of the fourth lens group in a wide-angle mode of the optical imaging system when the optical imaging system is focused on an object at infinity, and Mt is a magnification of the fourth lens group in a telephoto mode of the optical imaging system when the optical imaging system is focused on an object at infinity.

3. The optical imaging system according to claim 1, wherein 0.9≤L14/L4≤1.2 is satisfied, where L14 is a distance along the optical axis from an image-side surface of a lens disposed closest to the second lens group, among the lenses included in the first lens group, to an object-side surface of a lens disposed closest to the third lens group, among the lenses included in the fourth lens group, and L4 is a distance along the optical axis from the object-side surface of the lens disposed closest to the third lens group, among the lenses included in the fourth lens group, to the imaging surface.

4. The optical imaging system according to claim 1, wherein 0.8≤D11/D_last≤1.3 is satisfied, where D11 is an effective diameter of an object-side surface of a lens disposed closest to the reflective member, among the lenses included in the first lens group, and D_last is an effective diameter of an image-side surface of a lens disposed closest to the imaging surface, among the lenses included in the fourth lens group.

5. The optical imaging system according to claim 1, wherein 0.5≤D41/(2×IMG HT)≤0.8 is satisfied, where D41 is an effective diameter of an object-side surface of a lens disposed closest to the third lens group, among the lenses included in the fourth lens group, and IMG HT is one half of a diagonal length of the imaging surface.

6. The optical imaging system according to claim 1, wherein 1.0≤T_dG3/I_dG3≤ 1.4 is satisfied, where T_dG3 is a maximum movement amount of the third lens group in a telephoto mode of the optical imaging system, and I_dG3 is a maximum movement amount of the third lens group when the optical imaging system is focused on an object at infinity.

7. The optical imaging system according to claim 1, wherein 1.5≤fG1/D_last≤2.5 is satisfied, where fG1 is a focal length of the first lens group, and D_last is an effective diameter of an image-side surface of a lens disposed closest to the imaging surface, among the lenses included in the fourth lens group.

8. The optical imaging system according to claim 1, wherein −0.6≤(R13−R14)/(R13+R14)≤−0.2 is satisfied, where R13 is a radius of curvature of an object-side surface of a lens disposed closest to the third lens group, among the lenses included in the fourth lens group, and R14 is a radius of curvature of an image-side surface of the lens closest to the third lens group, among the lenses included in the fourth lens group.

9. The optical imaging system according to claim 1, wherein 1.5≤ft/L4≤2.2 is satisfied, where ft is an overall focal length of the optical imaging system in a telephoto mode of the optical imaging system when the optical imaging system is focused on an object at infinity, and L4 is a distance along the optical axis from an object-side surface of a lens disposed closest to the third lens group, among the lenses included in the fourth lens group, to the imaging surface.

10. The optical imaging system according to claim 1, wherein the second lens group has a negative refractive power, and the third lens group has a positive refractive power.

11. The optical imaging system according to claim 1, wherein the first lens group comprises a first lens and a second lens,
the first lens and the second lens have refractive powers having opposite signs, and
among the first and second lenses, an Abbe number of a lens having a positive refractive power is greater than 50, and an Abbe number of a lens having a negative refractive power is less than 35.

12. The optical imaging system according to claim 1, wherein the second lens group comprises a third lens and a fourth lens,
the third lens and the fourth lens have refractive powers having opposite signs, and
among the third and fourth lenses, an Abbe number of a lens having a positive refractive power is less than 21, and an Abbe number of a lens having a negative refractive power is greater than 45.

13. The optical imaging system according to claim 1, wherein the third lens group comprises a fifth lens and a sixth lens,
the fifth lens and the sixth lens have refractive powers having opposite signs, and
among the fifth and sixth lenses, an Abbe number of a lens having a positive refractive power is greater than 50, and an Abbe number of a lens having a negative refractive power is less than 30.

14. The optical imaging system according to claim 1, wherein the fourth lens group comprises a seventh lens, an eighth lens, a ninth lens, and a tenth lens, and
the seventh lens has a convex object-side surface in a paraxial region thereof and an Abbe number greater than 50.

15. The optical imaging system according to claim 14, wherein the aperture is disposed in front of the seventh lens, and
the seventh lens has a positive refractive power.

16. The optical imaging system according to claim 14, wherein the ninth lens or the tenth lens has at least one inflection point on either one or both of an object-side surface and an image-side surface thereof.

17. An optical imaging system comprising:
a first lens group, a second lens group, a third lens group, and a fourth lens group sequentially disposed in ascending numerical order along an optical axis of the optical imaging system away from an object side of the optical imaging system toward an imaging surface of the optical imaging system, and each comprising a plurality of lenses, and
an aperture disposed between the third lens group and the fourth lens group,
wherein each of the first lens group and the fourth lens group has a positive refractive power as a whole and is disposed at a fixed position on the optical axis,
the second lens group is configured to be movable along the optical axis to adjust a focal length of the optical imaging system between a wide-angle mode of the optical imaging system and a telephoto mode of the optical imaging system,
the third lens group is configured to be movable along the optical axis to adjust a focus position of the optical imaging system as the second lens group moves along the optical axis to adjust the focal length of the optical imaging system, and
0.95≤Mw/Mt≤1.05 is satisfied, where Mw is a magnification of the fourth lens group in the wide-angle mode when the optical imaging system is focused on an object at infinity, and Mt is a magnification of the fourth lens group in the telephoto mode when the optical imaging system is focused on an object at infinity.

18. The optical imaging system of claim 17, wherein 1.0≤T_dG3/I_dG3≤1.4 is satisfied, where T_dG3 is a movement amount of the third lens group between a position of the third lens group in the telephoto mode when the optical imaging system is focused on an object at a near focus distance, and a position of the third lens group in the telephoto mode when the optical imaging system is focused on an object at infinity, and I_dG3 is a movement amount of the third lens group between a position of the third lens group in the wide-angle mode when the image is focused on an object at infinity, and a position of the third lens group in the telephoto mode when the optical imaging system is focused on an object at infinity.

19. The optical imaging system of claim 17, wherein the second lens group has a negative refractive power as a whole, and
the third lens group has a positive refractive power as a whole.

20. The optical imaging system of claim 17, wherein the aperture is aligned with a vertex of an object-side surface of a lens disposed closest to the third lens group, among the lenses included in the fourth lens group.
